(19) United States
(12) Patent Application Publication
(10) Pub. No.: US 2012/0114140 A1
(43) Pub. Date: May 10, 2012

(54) SYSTEM AND METHOD FOR A NOISE REDUCTION CONTROLLER IN A COMMUNICATION DEVICE

(75) Inventor: Alon Konchitsky, Santa Clara, CA (US)

(73) Assignee: NOISE FREE WIRELESS, INC., Santa Clara, CA (US)

(21) Appl. No.: 13/286,017

(22) Filed: Oct. 31, 2011

Related U.S. Application Data
(60) Provisional application No. 61/410,289, filed on Nov. 4, 2010.

(51) Int. Cl. H04B 15/00

(52) U.S. Cl. 381/94.1

(57) ABSTRACT

A system and method control the level of applied noise reduction, the level of noise reduction being influenced by monitoring audio signals, analyzing audio signal components, bandwidth of background noise, user preferences and other factors.

### CROSS-REFERENCE TO RELATED APPLICATIONS

This is a utility application based upon U.S. patent application Ser. No. 61/410,289 e filed on Nov. 4, 2010. This related application is incorporated herein by reference and made a part of this application. If any conflict arises between the disclosure of the invention in this utility application and that in the related provisional application, the disclosure in this utility application shall govern. Moreover, the inventors incorporate herein by reference any and all patents, patent applications, and other documents hard copy or electronic, cited or referred to in this application.

### FIELD OF THE INVENTION

The invention relates to processing of audio signals and more specifically the invention relates to systems and method for a noise reduction controller in communication devices.

### BACKGROUND

Background noise or ambient noise is any sound other than the sound being monitored. Typically, background noise may be caused by engines, blowers, fans, air conditioners, cars, busy intersections, people talking in restaurants and so forth. If untreated, background noise can be annoying at times. Further, background noise is a major problem when processing audio signals.

Modern day communication devices operate in a myriad type of environments. Examples of communication devices include, but are not limited to, a mobile phone, wireless telephone and so forth. Some of the environments may be extremely noisy, for example bars, crowded restaurants and so forth, while some environments may be extremely quite such as home, relaxing lounge and so forth. Generally, the communication devices include microphone(s) that pick up the desired signal of the user and background noise (if present). As a result, the communication at the other end may not be clearly discernible or pleasant.

Typically for noise reduction, the audio signal is processed in a microprocessor by using noise reduction algorithms. The audio signal is picked up by the microphone, digitized by an Analog to Digital Converter (ADC) and fed to the microprocessor for analysis and noise reduction. The noise reduction algorithms, however, come at an expense of battery life, power, MIPS (Millions of Instructions per Second), huge program space, data space, crucial processing time and so forth. The performance of noise reduction techniques are often judged by the noise reduced (in decibels, dB) from the audio signal. The more the noise reduction, the more may be the power consumption, delay, processing time and so forth.

Communication devices may not always be used in the same kind of noisy environments and hence do not need fixed level of noise reduction. Communication devices with “fixed” noise reduction capability will always remove a fixed level of noise irrespective of the environment in which they are operating. For example, truck drivers mostly experience street noise, highway noise, truck noise and so forth. Construction workers mostly experience heavy equipment noise, construction site noise and so forth. Voice gateways, conference bridges and similar devices are affected with various kinds of background noise. Each kind of background noise may require different level of noise reduction.

In light of the above discussion, techniques are required to control the level of noise reduction in communication devices by automatically selecting a particular noise reduction level based on the background noise in which the device is operating.

### SUMMARY OF THE INVENTION

The present invention provides a novel system and method for monitoring the audio signals, analyze selected audio signal components and control the level of noise reduction in a communication device.

The invention controls the level of noise reduction based on various factors including, but not limited to, the bandwidth of the background noise, level of background noise, personal preference and so forth.

In one aspect of the invention, the noise reduction can be controlled in a pre-defined method by the user, manufacturer or can be set “on the fly” in real time during a telephonic conversation.

In another aspect of the invention, the invention can be used in communication devices which perform noise reduction on the received signals which are reproduced at the earpiece of the communication device.

In another aspect of the invention, the invention provides the flexibility to control the level of noise reduction in communication devices by automatically selecting a particular noise reduction level to save crucial processing times, data space, program space required by the noise reduction techniques. The current invention increases the channel capacity in gateways, conference bridges, networks, servers and any multi-channel environment by controlling the level of noise reduction.

In another aspect of the invention, the invention provides flexibility to the users to control the level of noise reduction and preserve the voice quality which is altered, modified by noise reduction techniques and achieve higher Mean Opinion Scores (MOS).

In another aspect of the invention, clear voice is provided in presence different levels, types of background noise in voice communication systems, devices, telephones, voice communication gateways, multi-channel environments and so forth.

In yet another aspect of the invention, the invention can be added as a module to the already existing devices with different levels of noise reduction capability. In such cases, the current invention enhances the battery life, reduces the power consumption, MIPS, program space, data space and so forth. However, it does not interfere with the native noise reduction algorithms.

Other features and advantages of the invention will become apparent to one with skill in the art upon examination of the following figures and detailed description. All such features, advantages are included within this description and be within the scope of the invention and be protected by the claims.

### BRIEF DESCRIPTION OF THE DRAWINGS

The invention is better understood in conjunction with detailed description and the figures. It should be noted that the components, blocks in the figures are not to scale and are used only for descriptive purposes.

FIG. 1A illustrates an exemplary embodiment of the noise reduction controller as discussed in the current invention;

FIG. 1B illustrates components of the noise reduction controller, in accordance with an embodiment of the invention;

FIG. 2 illustrates an exemplary implementation of the current invention in a Bluetooth headset;

FIG. 3 illustrates an exemplary implementation of the current invention in a mobile phone;

FIG. 4 illustrates an exemplary implementation of the current invention in a cordless phone;

FIG. 5 illustrates an exemplary implementation of the current invention in a VoIP gateway;

FIG. 6 illustrates an exemplary implementation of the current invention in a conference bridge environment;

FIG. 7 is a flowchart of a system with noise reduction controller, in accordance with an embodiment of the invention;

FIG. 8A is a flowchart detailing the steps of the noise reduction controller;

FIG. 8B is an alternate variant of the noise reduction controller described in FIG. 8A;

FIG. 9 is a flowchart detailing the steps of the noise reduction controller based on user preference.

FIG. 10 shows the plot of speech signal corrupted by background car noise.

FIG. 11 shows the plot of speech signal corrupted by background car noise after noise reduction (level 1).

FIG. 12 shows the plot of speech signal corrupted by background car noise after noise reduction (level 10).

### DETAILED DESCRIPTION OF EMBODIMENTS OF THE INVENTION

The following detailed description is directed to certain specific embodiments of the invention. However, the invention can be embodied in a multitude of different ways as defined and covered by the claims and their equivalents. In this description, reference is made to the drawings wherein like parts are designated with like numerals throughout.

Unless otherwise noted in this specification or in the claims, all of the terms used in the specification and the claims will have the meanings normally ascribed to these terms by workers in the art.

Hereinafter, preferred embodiments of the invention will be described in detail in reference to the accompanying drawings. It should be understood that like reference numbers are used to indicate like elements even in different drawings. Detailed descriptions of known functions and configurations that may unnecessarily obscure the aspect of the invention have been omitted.

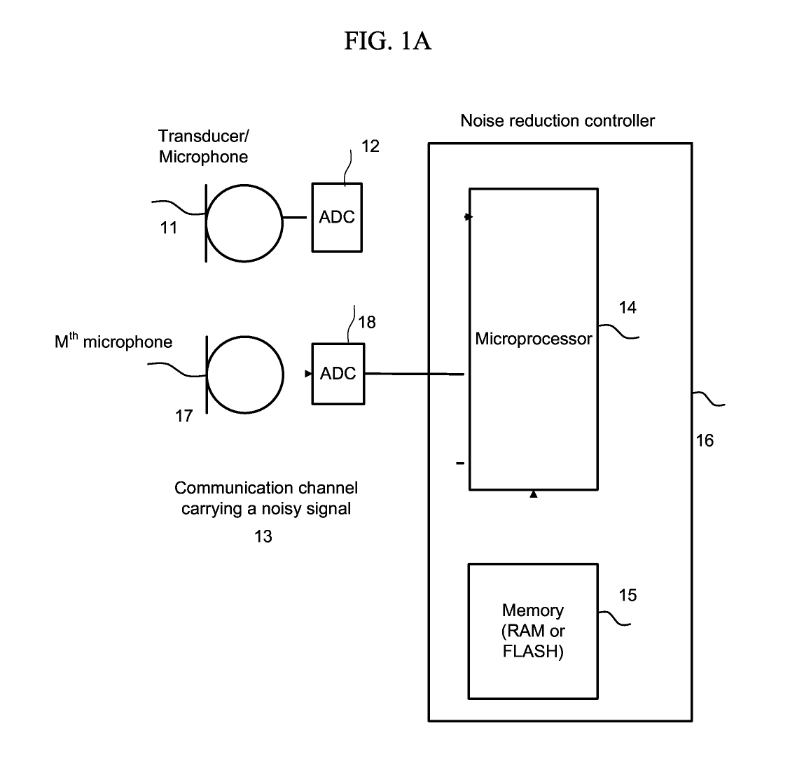

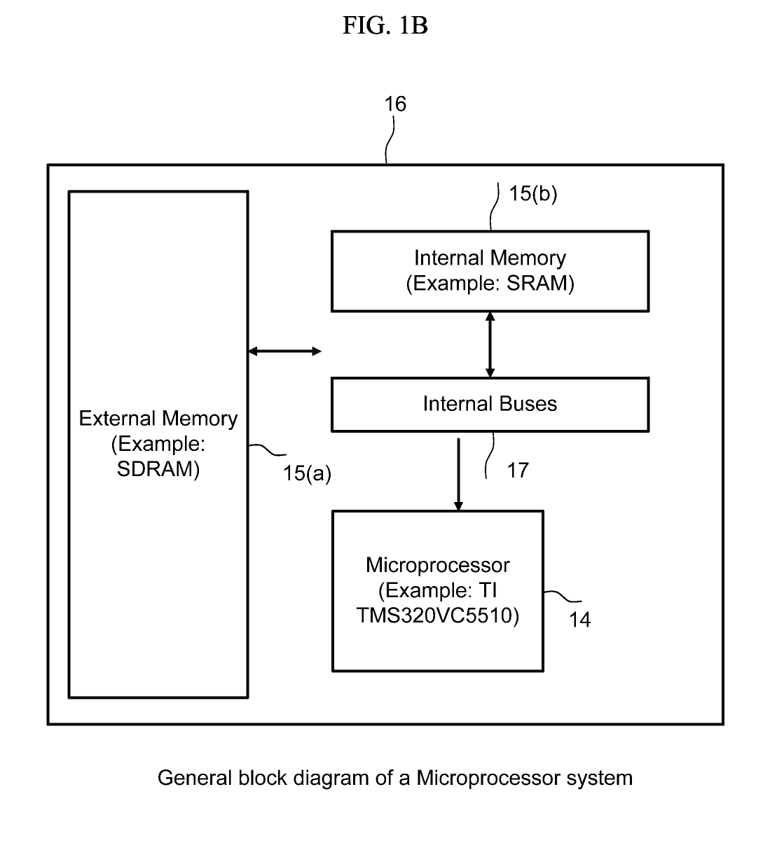

FIG. 1A shows the embodiments of the noise reduction controller as described in the current invention. The transducer/microphone, 11, of the communication device, picks up the analog signal. It should be noted by people skilled in the art that the communication device can have M number of microphone(s), where M>1. The Analog to Digital Converter (ADC), block 12, converts the analog signal to digital signal. Block 17 and 18 are M^{th} microphone and ADC respectively for a communication device with M microphones. The digital signal is then sent to the noise reduction controller, block 16. In general any communication signal received from a communication device, in its digital form, is sent to the noise reduction controller. The noise reduction controller (block 16) consists of a microprocessor, block 14 and a memory, block 15. The microprocessor can be a general purpose Digital Signal Processor (DSP), fixed point or floating point, or a specialized DSP (fixed point or floating point).

Examples of DSP include Texas Instruments (TI) TMS320VC5510, TMS320VC6713, TMS320VC6416 or Analog Devices (ADI) BF531, BF532, 533 and so forth or Cambridge Silicon Radio (CSR) Blue Core 5 Multi-media (BC5-MM) or Blue Core 7 Multi-media BC7-MM and so forth. In general, the noise reduction controller can be implemented on any general purpose fixed point/floating point DSP or a specialized fixed point/floating point DSP.

The memory can be Random Access Memory (RAM) based or FLASH based and can be internal (on-chip) or external memory (off-chip). The instructions reside in the internal or external memory. The microprocessor, in this case a DSP, fetches instructions from the memory and executes them.

FIG. 1B shows the embodiments of block 16. It is a general block diagram of a microprocessor system where noise reduction controller is implemented. The internal memory, block 15(b) for example, can be SRAM (Static Random Access Memory) and the external memory, block 15(a) for example, can be SDRAM (Synchronous Dynamic Random Access Memory). The microprocessor, block 14 for example, can be TI TMS320VC5510. However, those skilled in the art can appreciate the fact that the block 14, can be a microprocessor, a general purpose fixed/floating point DSP or a specialized fixed/floating point DSP. The internal buses, block 17, are physical connections that are used to transfer data. All the instructions required by the noise reduction controller reside in the memory and are executed in the microprocessor.

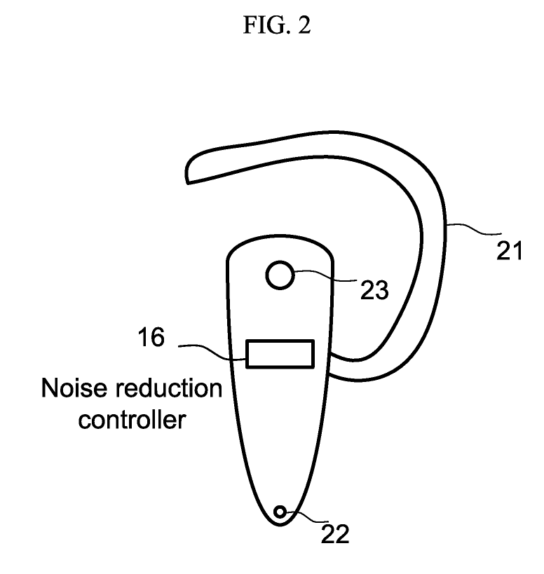

FIG. 2 shows a Bluetooth headset with the noise reduction controller. In FIG. 2, 22 is the microphone of the device. 23 is the speaker of the device. 21 is the ear hook of the device. Block 16 is the noise reduction controller which controls the level of noise reduction for the audio signal. People skilled in the art can appreciate the fact that the Bluetooth headset can have M number of microphone(s), where M≧1.

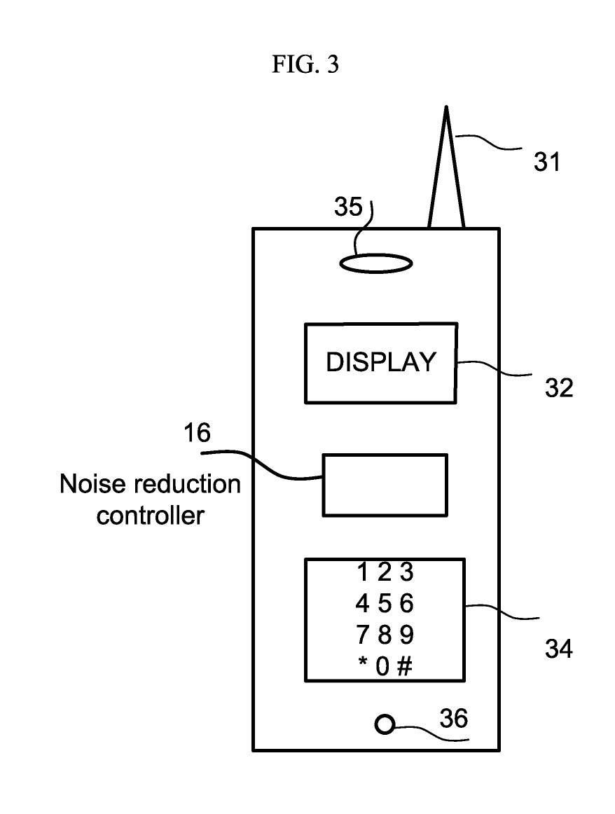

FIG. 3 shows a cell phone with the noise reduction controller. In FIG. 3, 31 is the antenna of the cell phone, 35 is the loudspeaker. 36 is the microphone. 32 is the display, 34 is the keypad of the cell phone. Block 16 is the noise reduction controller which controls the level of noise reduction for the audio signal. People skilled in the art can appreciate the fact that the cell phone can have M number of microphone(s), where M>1.

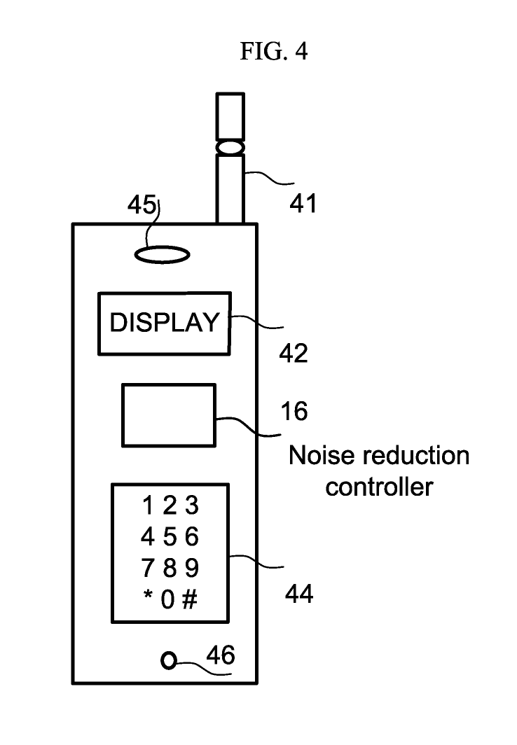

FIG. 4 shows a cordless phone with the noise reduction controller. In FIG. 4, 41 is the antenna of the cell phone, 45 is the loudspeaker. 46 is the microphone. 42 is the display, 44 is the keypad of the cell phone. Block 16 is the noise reduction controller which controls the level of noise reduction for the audio signal. People skilled in the art can appreciate the fact that the cordless phone can have M number of microphone(s), where M>1.

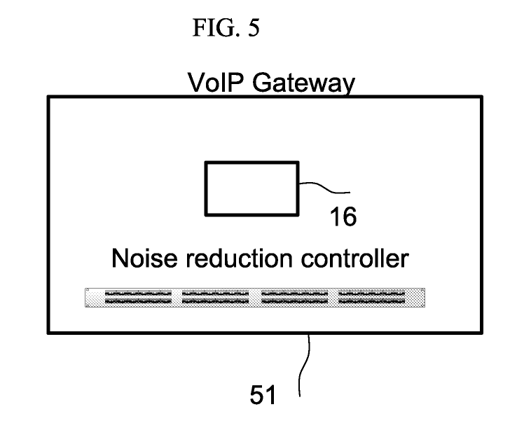

FIG. 5 shows a VoIP gateway, 51 with the noise reduction controller. Block 16 is the noise reduction controller which controls the level of noise reduction for the audio signal. People skilled in the art can appreciate the fact that the gateway can have single channel or multi channels.

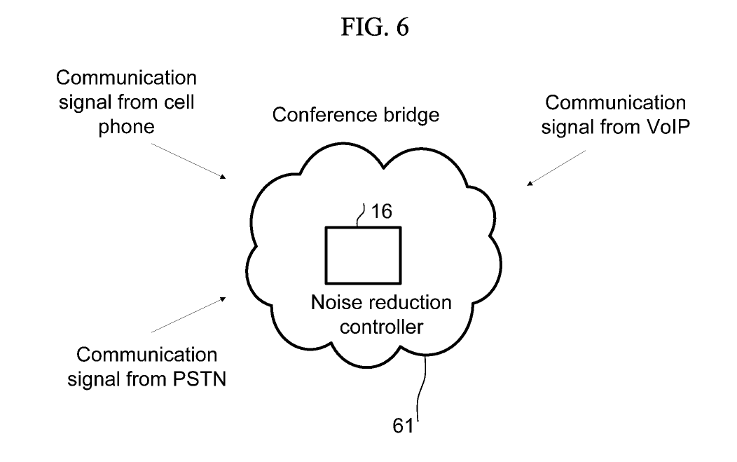

FIG. 6 shows a conference bridge, 61 with the noise reduction controller. Block 16 is the noise reduction controller which controls the level of noise reduction for the audio signal. People skilled in the art can appreciate the fact that the conference bridge can have single channel or multi channels.

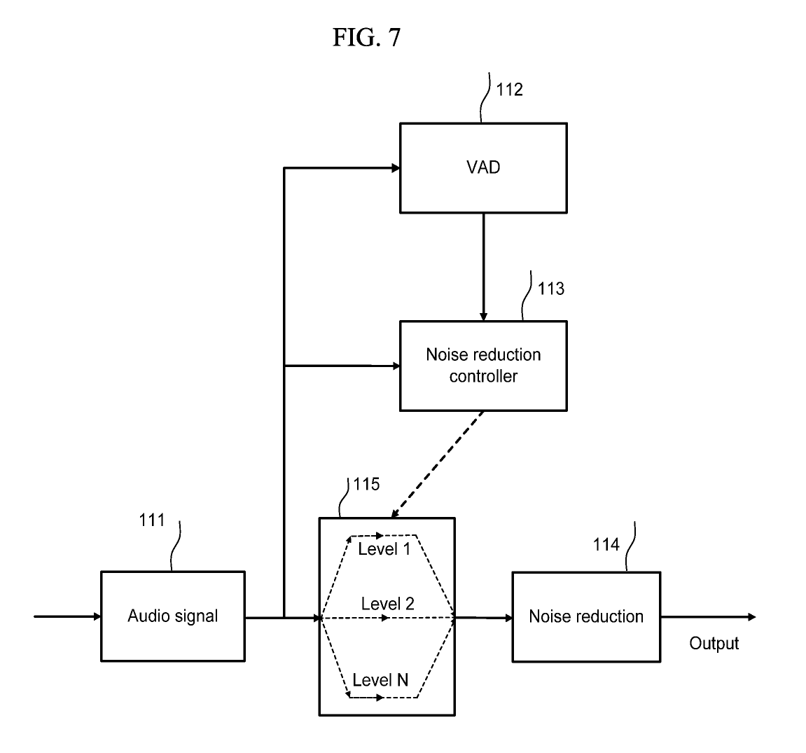

FIG. 7 shows various steps of the current invention involved in the process of controlling noise reduction. The audio signal is received at block 111. This audio signal may be the signal received in voice gateway, conference bridge and so forth. It may also be the signal(s) picked up by the communication device with one or M number of microphone(s), channels, where M>1.

Block 112 is a Voice Activity Detector (VAD). It is a technique used to detect the presence and absence of speech. VAD is used in many applications such as noise reduction, echo cancellation, speech coding, speech recognition and so forth. Many techniques to implement the VAD are known in the art (energy based VAD^{s}, zero cross detector VAD^{s} and so forth). One technique is described by J. F. Lynch Jr., J. G. Josenhans and R. E. Crochiere in paper titled “Speech/Silence Segmentation for real-time coding via rule based adaptive endpoint detection”, which is incorporated herein by reference. The purpose of the VAD is to decide if the audio signal is speech or noise/non-speech.

Block 113 is the noise reduction controller which controls the level of noise reduction for the audio signal in a communication device. Block 114 is the noise reduction technique of the communication device which reduces or removes the background noise from the audio signal. Several noise reduction algorithms are known in the art. One such technique is described by Steven F. Boll in “Suppression of Acoustic Noise in Speech Using Spectral Subtraction”, IEEE Transactions on Acoustics, Speech, and Signal Processing, Vol. Assp-27, No. 2, April 1979 and is incorporated herein by reference.

The noise reduction controller block 115 selects the level of noise reduction for the audio signal. The information about the level of noise reduction selected is sent to the noise reduction technique at block 114 which reduces the noise from the audio signal. The higher the level of noise reduction selected the higher is the noise reduced from the audio signal. There may be N levels of noise reduction, where N>1.

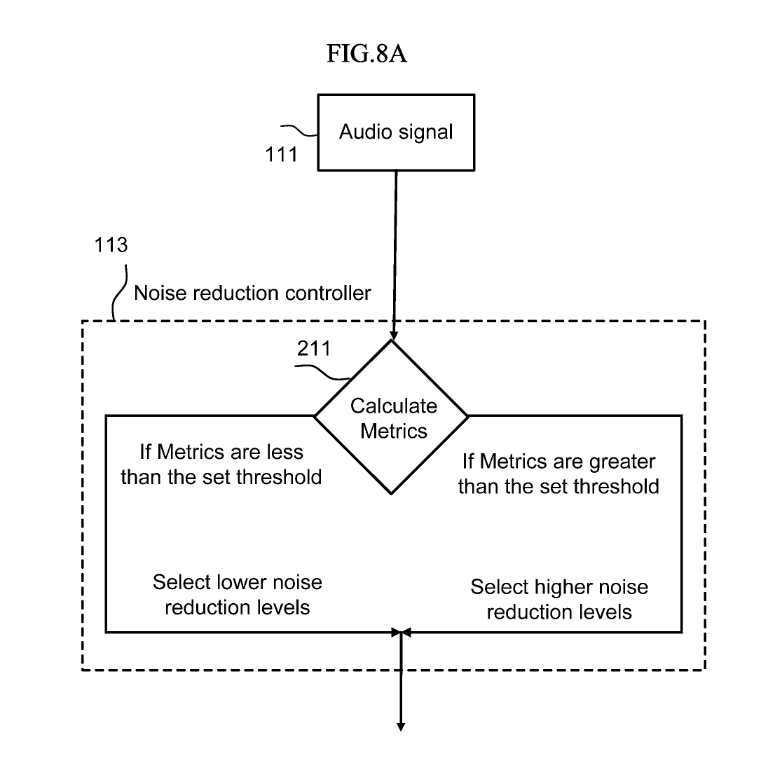

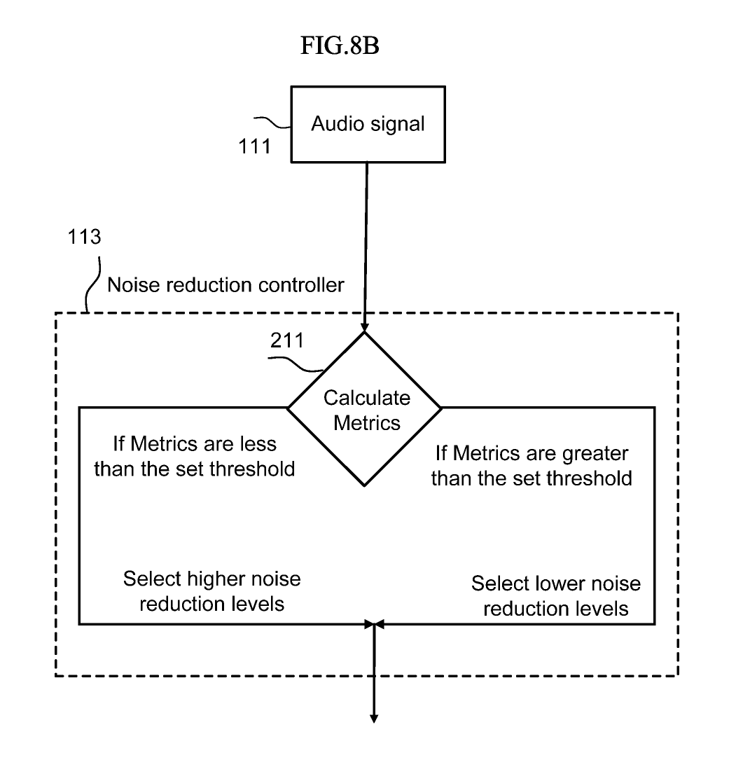

FIG. 8A shows the details involved in the noise reduction controller. The audio signal is received at block 111. Metrics are calculated at block 211. If the metrics are less than the set threshold, the noise reduction controller selects lower noise reduction levels (level 1, 2 and so forth) for the audio signal. If the metrics are greater than the set threshold, the noise reduction controller selects higher noise reduction levels for the audio signal (level N, N−1 and so forth). Various metrics may be calculated. These include, but not limited to, Root Mean Square (RMS) value, Mean Squared value, Energy, Power, Power Spectral Density (PSD), selected portions of the bandwidth and so forth of the audio signal.

FIG. 8B is an alternate variant of the noise reduction controller described in FIG. 8A;

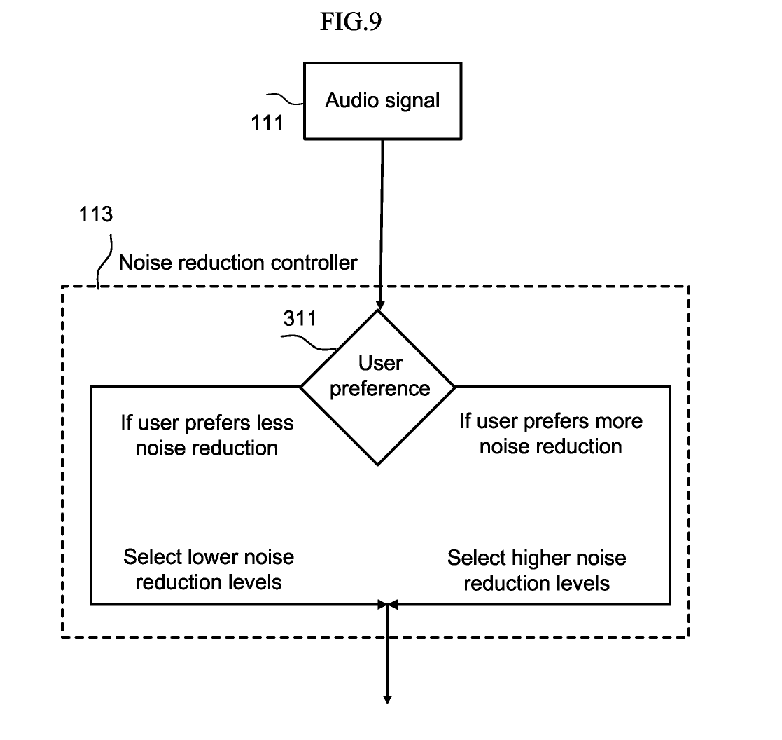

FIG. 9 shows the details involved in the noise reduction controller based on personal user preference. The audio signal is received at block 111. The user decides to use either lower levels of noise reduction or lower levels of noise reduction on the audio signal.

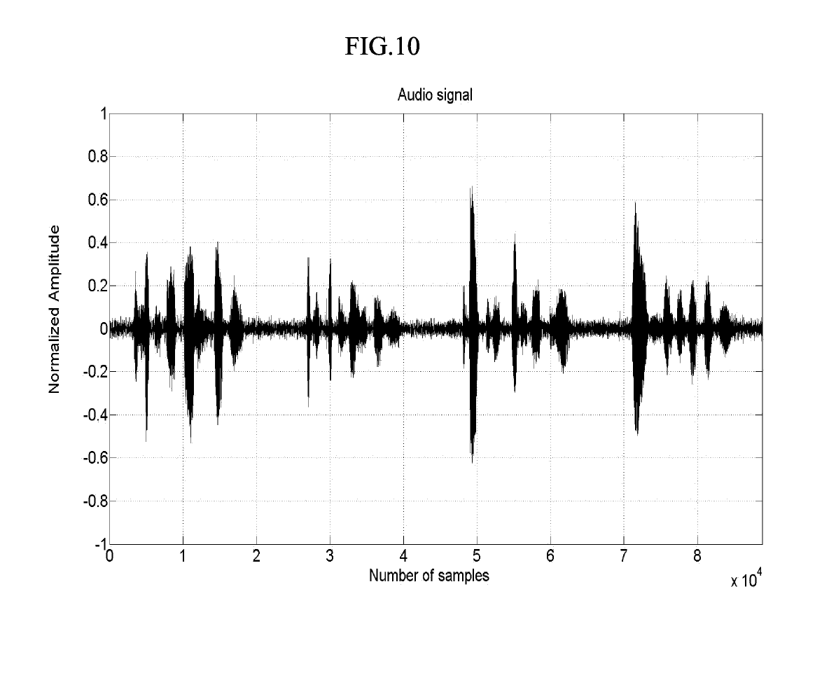

FIG. 10 shows the plot of audio speech signal corrupted by background car noise. The x-axis represents the number of samples and the y-axis represents the normalized amplitude [−1 1] of the audio signal. [−1 1] represents +32,767 to −32768 for 16-bit audio codecs.

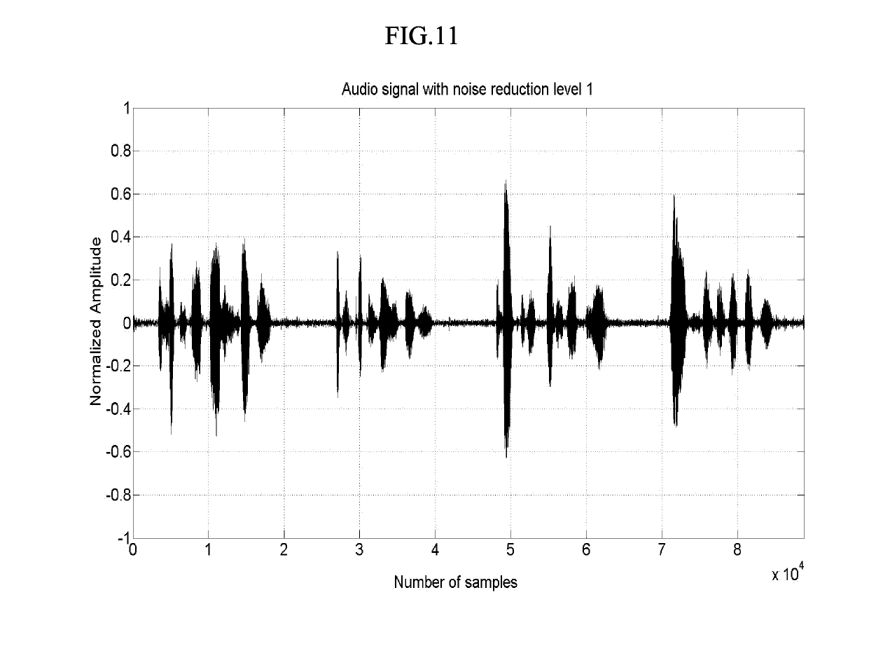

FIG. 11 shows the plot of audio speech signal described in FIG. 10 after noise reduction (level 1).

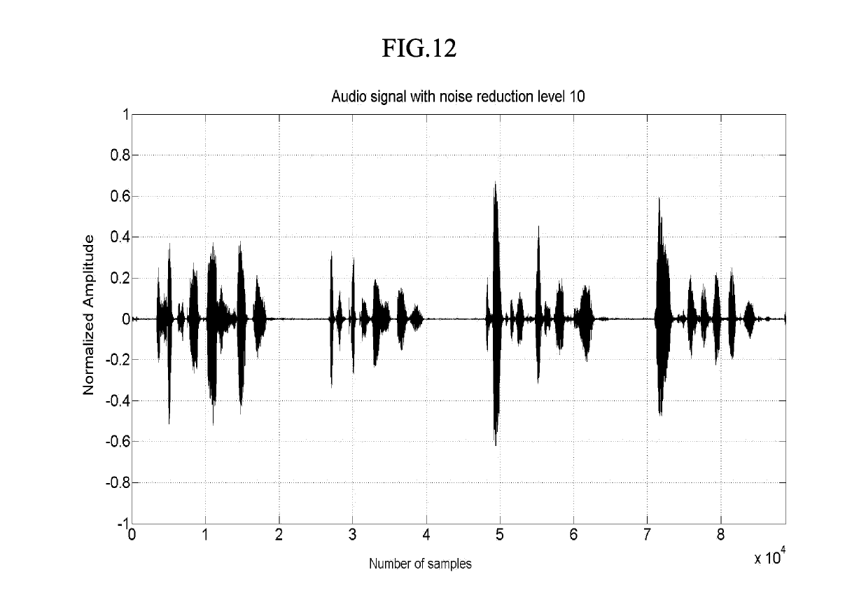

FIG. 12 shows the plot of audio speech signal described in FIG. 10 after noise reduction (level 10).

What is claimed is:

1. A device for generating an enhanced audio signal, comprising:
at least one audio input device configured to receive an input audio signal; and
a noise reduction controller configured to:
select a predefined noise reduction level for the input audio signal, wherein the predefined noise reduction level being selected based on a set of calculated metrics associated with the input audio signal; and
generate the enhanced audio signal from the input audio signal by reducing the noise in the input audio signal, wherein the noise is reduced based on the selected predefined noise reduction level.

2. The device of claim 1 further comprising a converter configured to convert the input audio signal to digital input audio signal.

3. The device of claim 1, wherein the set of calculated metrics include at least one of Root Mean Square (RMS) value, mean square value, energy, power, Power Spectral Density (PSD), or predefined portions of bandwidth of the input audio signal.

4. The device of claim 1, wherein the noise reduction controller is further configured to:
compare values of the set of calculated metrics with predefined threshold values; and
select the predefined noise reduction level based on the said comparison.

5. The device of claim 1, wherein the generating the enhanced audio signal increases the Mean Opinion Score (MOS) of the enhanced audio signal.

6. The device of claim 1, wherein a speech signal component in the input signal is preserved in the enhanced audio signal.

7. The device of claim 1, wherein the predefined noise reduction level being selected based on one or more user preferences.

8. A device for generating an enhanced audio signal, comprising:
a memory comprising one or more instructions for:
selecting a predefined noise reduction level for an input audio signal, wherein the predefined noise reduction level being selected based on a set of calculated metrics associated with the input audio signal; and
generating the enhanced audio signal from the input audio signal by reducing the noise in the input audio signal, wherein the noise is reduced based on the selected predefined noise reduction level; and
a processor coupled to the memory and configured to execute one or more instructions.

9. The device of claim 8, wherein the set of calculated metrics include at least one of Root Mean Square (RMS) value, mean square value, energy, power, Power Spectral Density (PSD), or predefined portions of bandwidth of the input audio signal.

10. The device of claim 8, wherein the memory further comprises one or more instructions for:
comparing values of the set of calculated metrics with predefined threshold values; and
selecting the predefined noise reduction level based on the said comparison.

11. The device of claim 8, wherein generating the enhanced audio signal increases the Mean Opinion Score (MOS) of the enhanced audio signal.

12. The device of claim 8, wherein the speech signal component in the input audio signal is preserved in the enhanced audio signal.

13. The device of claim 8, wherein the predefined noise reduction level being selected based on one or more user preferences.

14. A method for generating an enhanced audio signal, comprising:
selecting, at a noise reduction controller, a predefined noise reduction level for an input audio signal, wherein the predefined noise reduction level being selected based on a set of calculated metrics associated with the input audio signal; and
generating, at the noise reduction controller, the enhanced audio signal from the input audio signal by reducing the noise in the input audio signal, wherein the noise is reduced based on the selected predefined noise reduction level.

15. The method of claim 14, wherein the set of calculated metrics include at least one of Root Mean Square (RMS) value, mean square value, energy, power, Power Spectral Density (PSD), or predefined portions of bandwidth of the input audio signal.

16. The method of claim 14, further comprising:
comparing, at the noise reduction controller, values of the set of calculated metrics with predefined threshold values; and
selecting, at the noise reduction controller, the predefined noise reduction level based on the said comparison.

17. The method of claim 14, further comprises converting, at the noise reduction controller, the input audio signal to digital input audio signal.

18. The method of claim 14, wherein generating the enhanced audio signal increases a Mean Opinion Score (MOS) of the enhanced audio signal.

19. The method of claim 14, wherein the speech signal component in the input audio signal is preserved in the enhanced audio signal.

20. The method of claim 14, wherein the predefined noise reduction level being selected based on one or more user preferences.
